(19) United States
(12) Patent Application Publication
(10) Pub. No.: US 2016/0028960 A1
(43) Pub. Date: Jan. 28, 2016

(54) IMAGE PHOTOGRAPHING APPARATUS, METHOD OF PHOTOGRAPHING IMAGE AND NON-TRANSITORY RECORDABLE MEDIUM

(71) Applicant: SAMSUNG ELECTRONICS CO., LTD., Suwon-si (KR)

(72) Inventors: Jung-wan KO, Seongnam-si (KR); Hee-wan LEE, Seoul (KR)

(73) Assignee: SAMSUNG ELECTRONICS CO., LTD., Suwon-si (KR)

(21) Appl. No.: 14/799,204

(22) Filed: Jul. 14, 2015

(30) Foreign Application Priority Data
Jul. 22, 2014 (KR) 10-2014-0092799

(51) Int. Cl. H04N 5/232; G06T 3/40; H04N 5/91; G06T 3/60

(52) U.S. Cl. CPC H04N 5/23293; G06T 3/60; G06T 3/40; H04N 5/91

(57) ABSTRACT

An image photographing method is disclosed. The method includes photographing a subject, displaying a live view with respect to the subject and in response to sensing an inclination of the image photographing apparatus, rotating the subject image in the live view in an opposite direction of the inclination of the image photographing apparatus.

### CROSS-REFERENCE TO RELATED APPLICATION(S)

This application claims priority from Korean Patent Application No. 10-2014-0092799, filed on Jul. 22, 2014, in the Korean Intellectual Property Office, the disclosure of which is incorporated herein by reference in its entirety.

### BACKGROUND

1. Field

Apparatuses and methods that are consistent with the exemplary embodiments relate to an image-photographing apparatus, and more particularly, to an image photographing apparatus which easily photographs a subject horizontally or vertically, an image photographing method, and a non-transitory recordable medium thereof.

2. Description of Related Art

In a case where a picture or a video is photographed using a digital camera, a view finder of the digital camera displays a live view of a subject so that a user is able to confirm an image of the subject in real time.

However, in related art, when photographing a subject using a digital camera, it is difficult to photograph the subject without unintentionally inclining the camera because the user has to rely on a live view image displayed on a view finder to maintain the camera horizontally.

FIGS. 1 and 2 are views illustrating a live view image of a digital camera of related art.

FIG. 1 is a view illustrating an image 15 of a subject shown on a view finder 13 when the subject is photographed with the camera 10 placed horizontally. When the camera 10 is placed horizontally, an image of the subject is photographed uprightly on the ground.

FIG. 2 is a view illustrating the image 15 of a subject shown on the view finder 13 when the subject is photographed with the camera 10 inclined slightly. A user may photograph a subject while unintentionally placing the camera 10 non-horizontally, and in this case, the user gets a final photographed image which is inclined from the horizontal line. When the image is printed this way, the picture is awkward because the subject in the picture is inclined.

When a camera is turned non-horizontally to a certain degree, a subject is inclined based on an external angle of a view finder of the camera. However, the external angle of a live view finder is also inclined according to the camera's inclination. Thus, when no processing is performed on the live view screen when the subject is photographed, an image on the live view screen may seem to maintain an identical horizontality and verticality to the subject. That is, the image appears to maintain horizontality and verticality because the frame shown to the user is turned. Accordingly, when the user sets a frame horizontally and vertically after photographing the subject, the subject in the image is inclined.

To resolve a problem of an inclination of a camera during photographing, the view finder 13 of the camera 10 in related art may show gridlines 11, 12 in the horizontal and vertical directions as illustrated in FIG. 3 to help a user to photograph a subject horizontally. Otherwise, a digital camera may be equipped with a horizontal and vertical measuring device separately to provide an additional means to determine whether the horizontality and verticality of a subject and a digital camera are the same.

One reason why it is difficult to set a subject horizontally and vertically by watching a view finder or a live view of a camera is related to a user's recognition of people. Generally, when a user photographs, the user has a tendency to concentrate on a subject only without watching an inclination of an external angle of a view finder of a camera, and an inclination of a camera. The user puts the subject that he/she watches in the center and concentrates on the subject while photographing, and thus, even when a camera is inclined, the user does not feel strange when the subject does not seem to be inclined.

However, the technology in related art has a problem that when the gridlines in a view finder are too thick, the gridlines block a user's view and when the gridlines in the view finder are too thin, the user concentrates on a subject image as described above and it is difficult for the user to adjust horizontality. If the subject is not seen horizontally and vertically because of a wide-angle lens and the like, it is more difficult for the user to adjust horizontality and verticality.

If the horizontal and vertical measuring device is used, the horizontal and vertical measuring device is located on an exterior of an additional view finder or is attached to a tripod and it is difficult to confirm information of the horizontal and vertical measuring device when the user concentrates on a subject shown on a view finder and photographs the subject.

If a building becomes narrow as it goes up towards the top, and a corner of the building is expressed by an inclination because of the feature of a lens and the perspective, it may be difficult to determine the horizontal and vertical shape of the building accurately.

Accordingly, a technical method to easily photograph a subject horizontally and vertically is required.

### SUMMARY

In an aspect according to exemplary embodiments, there is provided an image photographing apparatus which easily photographs a subject horizontally or vertically, an image photographing method, and a non-transitory recordable medium thereof.

In an aspect according to an exemplary embodiment, there is provided an image photographing method, the method includes photographing a subject, displaying a live view with respect to the subject, and in response to sensing an inclination of an image photographing apparatus, rotating the subject image in the live view in an opposite direction of the inclination of the image photographing apparatus. In other words, considering an image shown on the live view after being photographed, an image where an image frame is maintained horizontally is displayed. Accordingly, a user may recognize intuitively that the subject that the user directly sees and the subject that the user sees through the live view or the view finder are inclined to each other.

The image photographing method may further include in response to sensing the inclination of the image photographing apparatus, maintaining a screen frame of the live view in a state of equilibrium and rotating the subject image within the screen frame in an opposite direction of the inclination of the image photographing apparatus.

The image photographing method may further include in response to an edge area of the screen frame of the live view deviating from a display screen, reducing a size of the rotated subject image.

The image photographing method may further include in response to sensing the inclination of the image photographing apparatus, rotating the subject image in an opposite direction by an amount equal to a rotation angle corresponding to an inclination of the image photographing apparatus in the live view.

The image photographing method may include in response to the inclination of the image photographing apparatus being in a predetermined range, rotating the subject image in the live view in an opposite direction of the inclination of the image photographing apparatus.

The image photographing method may further include displaying a user interface for selecting whether to rotate the subject image.

The image photographing method may further include in response to the subject being photographed, storing the subject image in a first buffer, and in response to sensing the inclination of the image photographing apparatus, reading a subject image stored in the first buffer and storing a subject image rotated in an opposite direction of the inclination of the image photographing apparatus in a second buffer.

The image photographing method may further include in response to the subject being photographed, reading a buffer where a live image inputted through a solid image sensor device is stored, reading a converted address considering an inclination in a reading process, and displaying the live view image on a display apparatus immediately to reduce an amount of a buffer added according to a rotation of a screen, and to prevent a time delay which occurs by storing a live view in the buffer and read again. In this case, the image is shown without scaling so the part of corner may be cut out naturally, and a part where an image does not exist in a screen may be generated. The part where an image does not exist may be displayed with a specific color which is designated in advance.

In an aspect according to another exemplary embodiment, there is provided an image photographing apparatus including an image capturer configured to capture an image of a subject, a display configured to display a live view with respect to the subject, an inclination detector configured to detect an inclination of the image photographing apparatus, an image processor configured to process the live view, and a controller configured to, in response to sensing an inclination of the image photographing apparatus being sensed, control the image processor to rotate the subject image in the live view in an opposite direction of an inclination direction.

The controller in response to sensing the inclination of the image photographing apparatus, may control the image processor to maintain a screen frame of the live view in a state of equilibrium and to rotate the subject image within the screen frame in an opposite direction of the inclination of the image photographing apparatus.

The controller in response to an edge area of the screen frame of the live view deviating from a display screen, may control the image processor to reduce a size of the rotated subject image.

The controller in response to the inclination of the image photographing apparatus being in a predetermined range, may control the image processor to rotate the subject image in the live view in an opposite direction of the inclination of the image photographing apparatus; and in response to the inclination of the image photographing apparatus being outside of a predetermined range, may control the image processor to not rotate the subject image in the live view.

The controller in response to sensing the inclination of the image photographing apparatus, may control the image processor to rotate the subject image in the live view in an opposite direction and by an amount equal to a rotation angle corresponding to the inclination of the image photographing apparatus.

The controller may control the display to display a user interface to select whether to rotate the subject image.

The image photographing apparatus may further include an inputter configured to receive a user input to select whether to rotate the subject image.

The image photographing apparatus may further include a first buffer and a second buffer wherein the controller in response to the subject being photographed, stores the subject image in the first buffer, and in response to sensing the inclination of the image photographing apparatus, reads the subject image stored in the first buffer and stores the subject image rotated in an opposite direction of the inclination of the image photographing apparatus in the second buffer.

A non-transitory recordable medium may record a computer program for implementing the image photographing method according to claim 1.

According to an aspect of another exemplary embodiment, there is provided an image photographing apparatus including an image capturer configured to capture an image of a subject, a display configured to display a live view of the image of the subject, and a controller configured to, in response to detecting an inclination of the image photographing apparatus, rotate the image of the subject in the live view in a direction opposite to the inclination of the image photographing apparatus.

The image photographing apparatus may further include wherein the detecting the inclination of the image photographing apparatus is performed with an accelerometer.

The image photographing apparatus may further include wherein the display includes a user interface that may be configured to receive an input from a user for selecting whether to rotate the image of the subject, and in response to the user selecting to not rotate the image of the subject, the controller may be configured to not rotate the image of the subject in the live view.

The image photographing apparatus may further include wherein in response to detecting the inclination of the image photographing apparatus, the display may be further configured to display a screen frame, and the controller may be configured to rotate the image of the subject within the screen frame in a direction opposite to the inclination of the image photographing apparatus.

According to various exemplary embodiments, aspects of the exemplary embodiments provide an image photographing apparatus which easily photographs a subject horizontally or vertically, an image photographing method and a non-transitory recordable medium thereof.

### BRIEF DESCRIPTION OF THE DRAWINGS

FIGS. 1 and 2 are views illustrating a circumstance where a live view image of a digital camera and a picture after photographing are displayed on a screen;

FIG. 3 is a view illustrating a live view image of a digital camera including gridlines;

FIG. 4 is a block diagram illustrating a configuration of an image photographing apparatus according to an exemplary embodiment;

FIGS. 5A and 5B are views illustrating a live view screen according to an exemplary embodiment;

FIGS. 6A and 6B are block diagrams illustrating a configuration of a buffer for a live view image according to an exemplary embodiment;

FIG. 7 is a block diagram illustrating a configuration of an image photographing apparatus according to an exemplary embodiment;

FIG. 8 is a block diagram illustrating a circuit configuration of an image processor according to an exemplary embodiment;

FIG. 9 is a block diagram illustrating a configuration of an image processor circuit;

FIG. 10 is a view illustrating a user interface according to an exemplary embodiment; and

FIGS. 11 and 12 are flowcharts illustrating an image photographing method according to an exemplary embodiment.

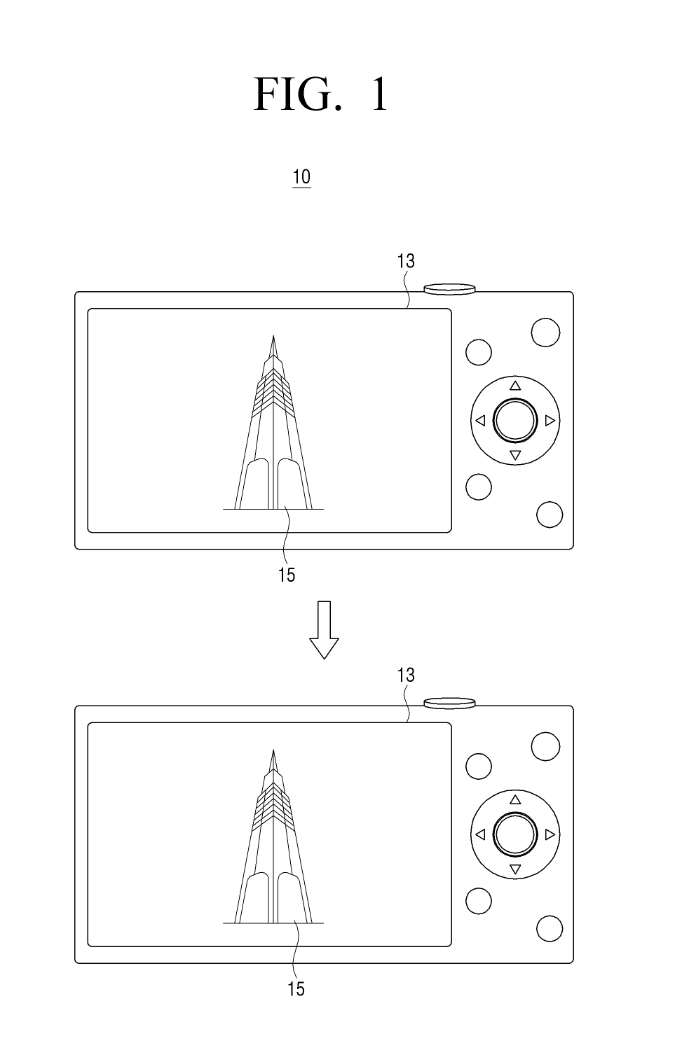

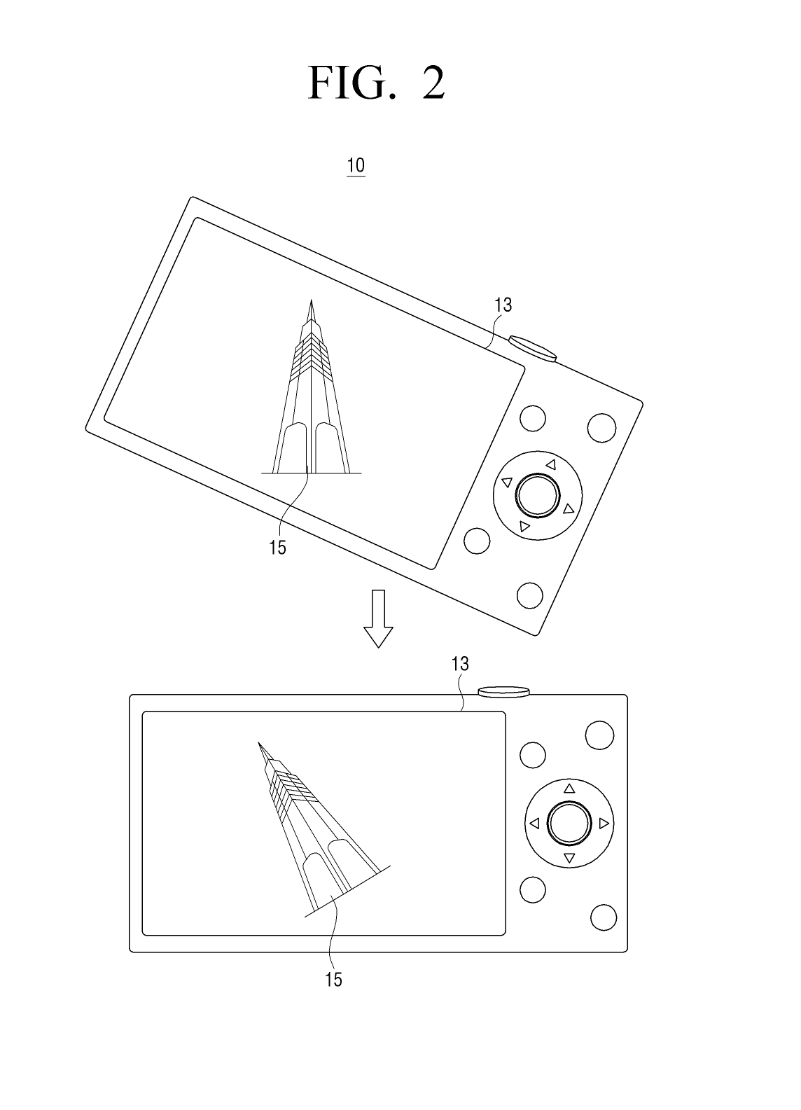

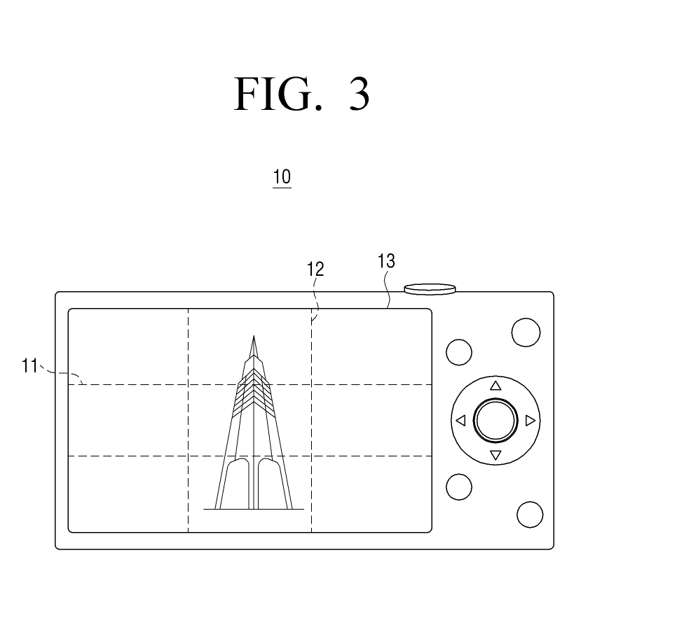

### DETAILED DESCRIPTION

Various exemplary embodiments are described with reference to attached drawings.

An image photographing apparatus according to an exemplary embodiment may be realized as various electronic apparatuses. For example, the image photographing apparatus may be realized as one of a digital camera, a smart phone, smart glasses, a tablet personal computer (PC), a cellular phone, an MP3 player, and a portable multimedia player (PMP).

Unless stated otherwise, expressions such as “at least one of,” when preceding a list of elements, modify the entire list of elements and do not modify the individual elements of the list.

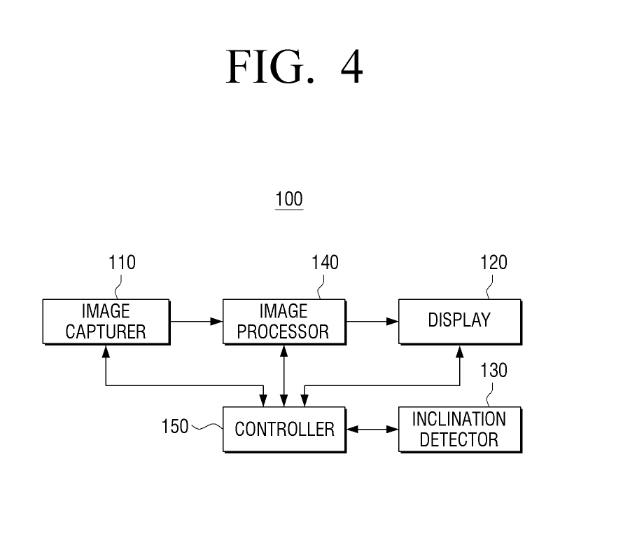

FIG. 4 is a block diagram illustrating a configuration of an image photographing apparatus 100 according to an exemplary embodiment.

Referring to FIG. 4, the image photographing apparatus 100 includes an image capturer 110, a display 120, an image processor 140, an inclination detector 130 and a controller 150.

The image capturer 110 photographs a subject and generates an image. The image capturer 110 includes a lens, a shutter, an aperture, a solid image sensor device, an analog front end (AFE), and a timing generator (TG). The shutter controls an amount of time where light reflected on a subject comes into the image photographing apparatus 100, and the aperture mechanically increases or decreases a size of an opening where light comes and controls the amount of incident lights. The solid image sensor device accumulates lights reflected on the subject as photocharge and outputs an electronic signal corresponding to an image of the photocharge. The TG outputs a timing signal for reading out pixel data of the solid image sensor device, and the AFE performs a sampling and digitalizes the electronic signal output from the solid image sensor device. Each configuration will be explained in detail below.

The display 120 displays a live view with respect to the subject. A live view image may process and output every pixel data of the solid image sensor device. Also, the live view data may be configured by a skip readout method which repeats reading out and skipping at intervals of a predetermined pixel. In this case, a resolution may be reduced in comparison with raw data.

The inclination detector 130 detects an inclination of the image photographing apparatus 100. The inclination detector 130 may detect an inclination of the image photographing apparatus 100 in real time. For this, the inclination detector 130 may include an acceleration sensor. Detected inclination information is transmitted to the controller 150.

The image processor 140 image-processes the live view. The image processor 140 may process raw image data and make the data into YCbCr. The image 140 processor may determine an image black level and may control a sensitivity rate according to colors. The image processor 140 may also control a white balance, and perform a gamma correction, a color interpolation, a color compensation, and a resolution conversion. Detailed configuration and operations of the image processor 140 will be explained below. Also, the image processor 140 may rotate a subject image in an opposite direction of an inclination direction of the image photographing apparatus 100 in a live view under a control of the controller 150.

The controller 150 controls overall operations of the image photographing apparatus 100. The controller 150 controls the image capturer 110 and acquires raw image data, and the controller 150 controls the image processor 140 and displays a live view image on the display 120. In response to an inclination of the image photographing apparatus 100 being sensed, the controller 150 may control the image processor 140 to rotate a subject image in an opposite direction of an inclination direction of the image photographing apparatus in a live view.

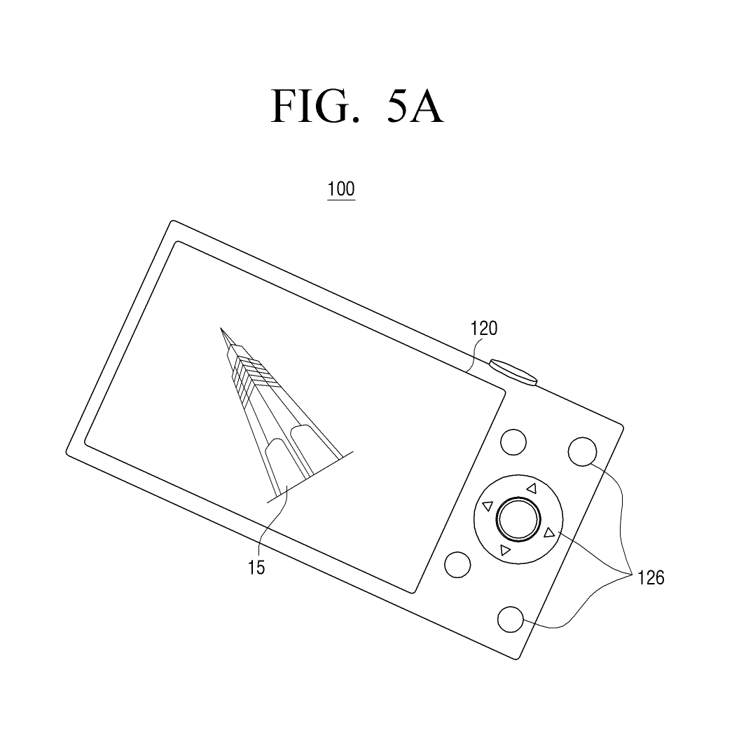

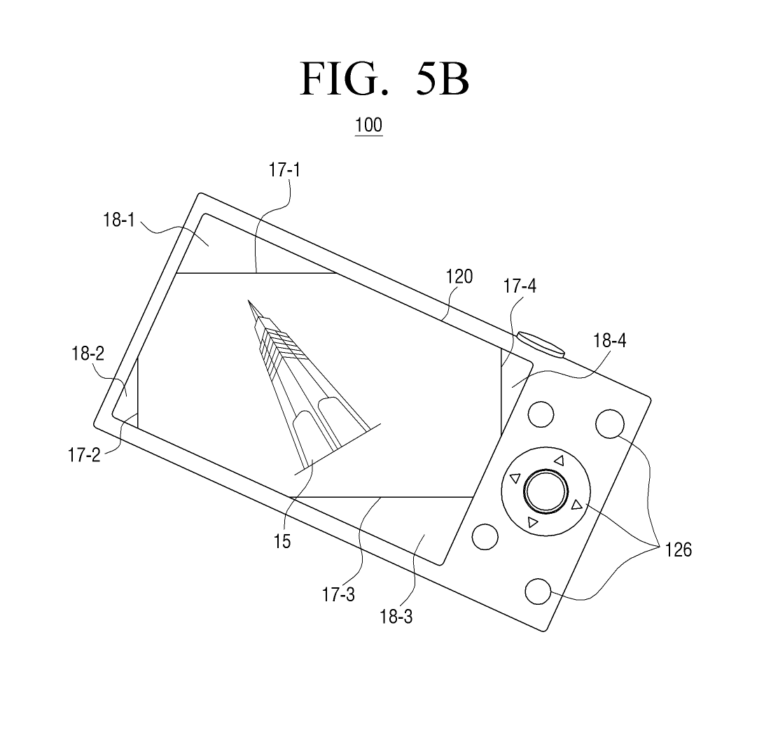

FIGS. 5A and 5B are views illustrating a live view screen according to an exemplary embodiment.

As illustrated in FIG. 5A, when photographing is performed in a state where the image photographing apparatus 100 is inclined, a subject 15 is displayed at an angle opposite to the inclination of the image photographing apparatus 100. As illustrated in FIG. 5A, a screen frame of a live view might not be displayed and only the subject image 15 may be displayed. However, in this case, it is difficult for a user to confirm whether the image photographing apparatus 100 is situated horizontally.

In another exemplary embodiment, as illustrated in FIG. 5B, a screen frame 17 of a live view may be displayed. In this case, the screen frame 17 of the live view maintains a state of equilibrium fixedly. Accordingly, when the image photographing apparatus 100 is inclined in a direction, up down left right edges 17-1, 17-2, 1-3, 17-4 of the screen frame 17 are exposed. Areas outside edges 18-1, 18-2, 18-3, 18-4 may be displayed as a block or by other single colors.

Through the configuration above, the user can easily recognize how much the image photographing apparatus 100 is inclined from the horizontal. The subject 15 is displayed in an opposite direction of an inclination direction of the image photographing apparatus 100, and thus, the user is able to easily recognize how much the final image generated after photographing is inclined. Accordingly, the user may situate the image photographing apparatus properly and then photograph the subject 15 referring to the live view.

In FIG. 5B, the screen frame 17 of the live view is not displayed entirely on the display 120 and some parts are cut out, but the entire screen frame 17 may be displayed on the display 120. In this case, the amount of screen frame cut out may be determined according to the degree of inclination of the image photographing apparatus 100, so that a technical method of reducing or expanding the screen frame 17 of a live view may be performed according to the degree of inclination of the image photographing apparatus 100. When edge areas 17-1, 17-2, 17-3, 17-4 of a screen frame of the live view deviates from a display screen, the image processor 140 may reduce a size of a rotated subject image and a screen frame. In other words, the image processor 140 may scale-up and/or scale-down the screen frame of the photographed live view and the rotated subject image to be suitable to a screen size according to the degree of inclination of the image photographing apparatus 100.

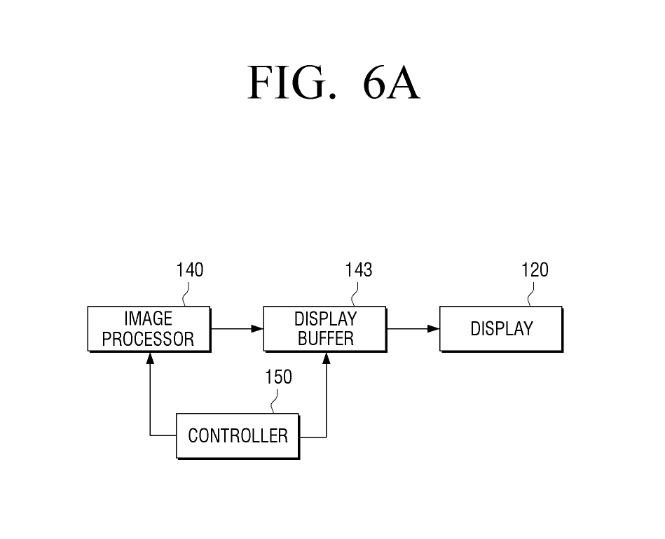

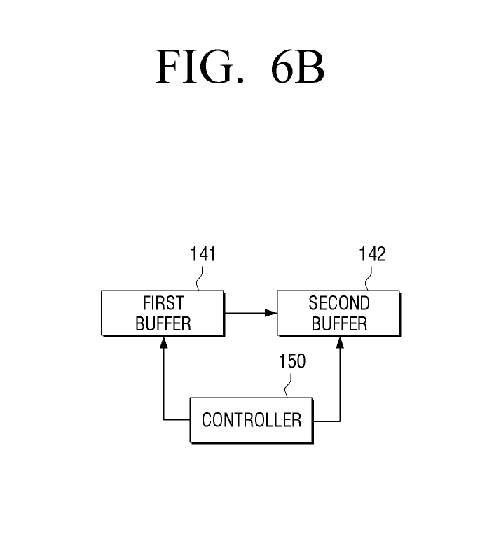

FIGS. 6A and 6B are block diagrams illustrating a buffer configuration for a live view image according to an exemplary embodiment.

FIG. 6A is a block diagram illustrating a connection among display buffer 143, the display 120 and the image processor 140 for a general live view process. When an image process is finished, the image is moved to the display buffer, and then displayed from the display buffer 143 according to the feature of the display 120.

To minimize the previous process configuration and time delay, when an address is recorded in the display buffer 143 by the image processor 140, the controller 150 calculates the address of a location recorded as much as it is inclined, and records a converted address in the display buffer 143. Thus, the inclined degree of the image may be processed.

With the above method, an address is simply mapped, and there is no need to go through a separate buffer. Thus, the process time to display is reduced and a delay between a live view and a movement of a real subject may be reduced. However, when an additional calculation that is complicated, such as an adjustment of an image size, is needed during the process, a separate buffer may be added.

Referring to FIG. 6B, the image photographing apparatus 100 according to an exemplary embodiment may include the first buffer 141 and the second buffer 142. These configurations may be included in the image processor 140 described above. The image processor 140 image-processes raw image data of a previously photographed image, generates an original live view image, and stores the original live view image in the first buffer 141. When the image photographing apparatus 100 is inclined in a direction, the image processor 140 may read the original live view image (a subject image) stored in the first buffer 141, and may store the image data, which is rotated in an opposite direction of the inclination direction of the image photographing apparatus 100, in the second buffer 142. The display 120 may output image data stored in the second buffer 142. The first buffer 141 and the second buffer 142 may each be set as a specific address range on a memory. The memory may be one of a synchronous dynamic random access memory (SDRAM), a flash memory, and a memory card, and also may be an external storing medium. As described above, the image photographing apparatus 100 according to an exemplary embodiment is able to process by moving a stored image of a memory to a new location in a new buffer, and thus, a complicated image process calculation is not needed. If an additional buffer is included, a calculation that is more complicated, such as an adjustment of an image size and the like, may be performed.

A rotation of a live view image is possible only when an absolute value of an inclination of the image photographing apparatus is larger than 0° and less than a predetermined value, because the user may take a picture rotating a camera about 45° intentionally. For example, when the image photographing apparatus 100 is inclined to the left or right less than 15°, the live view image may be inclined and displayed for the same degree in an opposite direction of an inclination direction of the image photographing apparatus. When the image photographing apparatus 100 is inclined more than 15°, it may be determined that the user intentionally inclines the image photographing apparatus 100 and photographs a subject so that the live view image is not rotated and displayed as it is. Therefore, when the image photographing apparatus 100 is inclined for not less than 75° and less than 105° based on a horizontal plane, the live view image may be inclined and displayed for the same degree in an opposite direction of an inclination direction of the image photographing apparatus as described above, considering that it is difficult for the user to recognize that the image photographing apparatus 100 is inclined when the image photographing apparatus 100 is stood vertically.

A range where a live view image is rotated reflecting a rotation state of the image photographing apparatus 100 may be set by a user input. Therefore, even when the image photographing apparatus is inclined slightly, a live view image may be displayed as it is further inclined for the user to recognize the inclination certainly.

A detailed configuration of the image photographing apparatus according to an exemplary embodiment will now be explained.

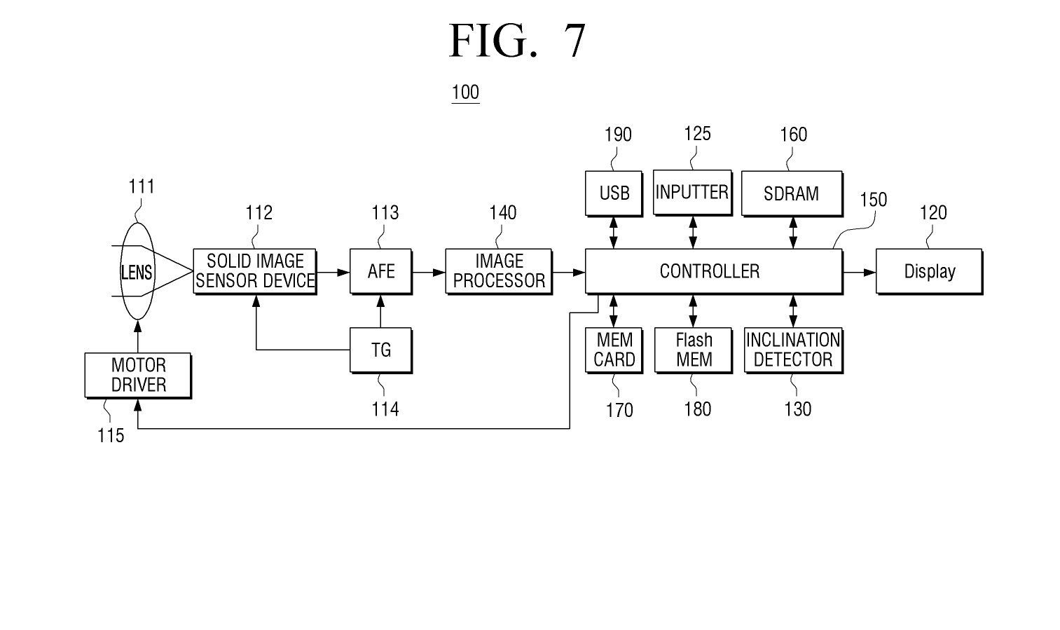

FIG. 7 is a block diagram illustrating a configuration of the image photographing apparatus 100 according to an exemplary embodiment.

Referring to FIG. 7, the image photographing apparatus 100 according to an exemplary embodiment includes a lens 111, a solid image sensor device 112, a timing generator (TG) 114, an analog front end (AFE) 113, a motor driver 115, a controller 150, a USB module 190, a SDRAM module 160, a memory card 170, a flash card 180, a display 120 and an inputter 125.

Light reflected on a subject enters into the lens 111, and the lens 111 includes at least one lens between a zoom lens and a focus lens. The image photographing apparatus 100 may be further equipped with an aperture.

The aperture is configured to control an amount of incident light which passes through the lens 111 and enters into the inside of the image photographing apparatus 100. The aperture includes a mechanical feature that gradually increases or decreases a size of an opening to control the amount of incident light. The aperture displays the openness with an aperture figure which is called F figure, also known as f-numbers or f-stops.

The solid image sensor device 112 is configured to form an image of a subject which passes through the lens 111. The solid image sensor device 112 includes a plurality of pixels located in a shape of a matrix. A plurality of pixels accumulates photocharge according to incident light and outputs an image formed by the photocharge as an electronic signal. The solid image sensor device 112 may consist of a complementary metal oxide semiconductor (CMOS) or a charge coupled device (CCD).

The solid image sensor device 112 may include a photo diode (PD), a transmission transistor (TX), a reset transistor (RX), and a floating spread node (FD). The photo diode (PD) generates and accumulates photocharge corresponding to an optical image of a subject. The transmission transistor (TX) responds to a transmission signal and transmits the photocharge generated in the (PD) to the floating spread node (FD). The reset transistor responds to a reset signal and emits photocharge stored in the floating spread node (FD). The photocharge stored in the floating spread node (FD) is output before the reset signal is authorized. In a case of a correlated double sampling (CDS), a correlated double sampling process is performed. Also, an analog-to-digital converter (ADC) converts an analog signal where the CDS process is performed to a digital signal.

The TG 114 outputs a timing signal for reading out pixel data of the solid image sensor device 112. The TG 114 is controlled by the controller 150.

The AFE 113 performs sampling and digitalizes an electronic signal of a subject image output from the solid image sensor device 112. The AFE 113 is controlled by the controller 150.

However, other configurations which are able to replace the AFE 113 and TG 114 as described above may be included, especially if the solid image sensor device 112 is realized as a shape of CMOS.

The motor driver 115 drives a focusing lens based on information calculated by reading out phase difference pixel, and takes a focus.

The image processor 140 image-processes raw image data by a control of the controller, records image-processed data on the SDRAM 160, and transmits the image-processed data in the SDRAM 160 to the display 120.

As described above, the inclination detector 130 is configured to detect an inclination of the image photographing apparatus 100. The inclination detector 130 may detect an inclination of the image photographing apparatus 100 in real time. For this, the inclination detector 130 may include an acceleration sensor, i.e. an accelerometer. The detected inclination information is transmitted to the controller 150.

The acceleration sensor may be realized as 2 axes or 3 axes. For example, if the acceleration sensor is realized as a 2-axes acceleration sensor, the acceleration sensor is equipped with an X-axis acceleration sensor and a Y-axis acceleration sensor which cross mutually. If the acceleration sensor is realized as a 3-axes acceleration sensor, the acceleration sensor is located indifferent directions than each other, and is equipped with an X-axis acceleration sensor, a Y-axis acceleration sensor, and a Z-axis acceleration sensor which cross mutually.

The acceleration sensor converts each output value of the X-axis, Y-axis and Z-axis acceleration sensors to a digital value and provides the digital value to the controller 150 (a separate sensor controller may be included). The inclination detector 130 may include a chopping circuit, an amplifier circuit, a filter, an A/D converter and the like. Accordingly, an electronic signal outputted from the 3 axes acceleration sensor is chopped, amplified, and filtered, and then converted to a digital voltage value.

If the acceleration sensor is vitalized, and an output value of the acceleration sensor of each axis is output and processed by the signal processor circuits, the controller 150 performs a normalization operation which maps an output value of each axis to a predetermined range, and then calculates a pitch angle and a roll angle using a normalized value.

If the 2-axes acceleration sensor is prepared, the controller 150 may perform a normalization operation using an equation below.

$${Xt}_{norm} = \frac{( Xt - {Xt}_{offset} )}{{Xt}_{Scale}} \\ {Yt}_{norm} = \frac{( Yt - {Yt}_{offset} )}{{Yt}_{Scale}} \\ {Xt}_{offset} = \frac{{Xt}_{max} + {Xt}_{min}}{2} , {Xt}_{Scale} = \frac{{Xt}_{max} - {Xt}_{min}}{2} \\ {Yt}_{offset} = \frac{{Yt}_{max} + {Yt}_{min}}{2} , {Yt}_{Scale} = \frac{{Yt}_{max} - {Yt}_{min}}{2} \qquad [ Equation 1 ]$$

In Equation 1, Xt and Yt represent an output value of an X-axis and a Y-axis acceleration sensors, respectively, Xtₙₒᵣₘ and Ytₙₒᵣₘ represent a normalized value of an the X-axis and the Y-acceleration sensors, respectively, Xtₘₐₓ and Xtₘᵢₙ represent a maximum value and a minimum value of Yt, respectively, Xt_{offset} and Yt_{offset} represent an offset value of X-axis and Y-axis acceleration sensors, respectively, and Xt_{Scale} and Yt_{Scale} represents a scale value of X-axis and Y-axis acceleration sensors, respectively. Xt_{offset}, Yt_{offset}, Xt_{Scale}, and Yt_{Scale} may be calculated by rotating the image photographing apparatus equipped with an acceleration sensor, and then they may be stored in a storage unit which is located in the inside of the acceleration sensor.

The controller 150 may substitute an acceleration sensor value of each axis which is normalized as Equation 1, to an equation below and calculates a pitch angle and a roll angle.

$$θ = {sin}^{- 1} ( {Xt}_{norm} ) \\ φ = {sin}^{- 1} ( \frac{{Yt}_{noram}}{cos θ} ) \qquad [ Equation 2 ]$$

In Equation 2, θ represents a pitch angle, and φ represents a roll angle.

In a case of a 3 axes acceleration sensor, the controller 150 performs a normalization operation which maps an output value of X-axis, Y-axis, and Z-axis acceleration sensors to a value of a predetermined range, and calculates a pitch angle and roll angle using the normalized value. The controller 150 may determine an inclination of the image photographing apparatus 100 using information regarding the calculated pitch angle and roll angle.

The image processor 140 may process raw image data and turn it into YCbCr data. Also, the image processor 140 may determine an image black level and controls a sensitivity rate according to colors. Also, the image processor controls a white balance, and performs a gamma correction, a color interpolation, a color compensation, and a resolution conversion. Detailed configurations and operations of the image processor 140 will be explained below.

The controller 150 controls overall operations of the image photographing apparatus 100. The controller 150 may differentiate readout phase difference pixel data from general pixel data, and may calculate phase difference using phase difference pixel data. The controller 150 may calculate a movement of a focus lens based on the calculated phase difference and controls the motor driver 115 so that the focusing lens is driven.

The controller 150 controls the image capturer 110 and acquires raw image data. The controller 150 controls the image processor 140 and displays a live view image on the display 120. If an inclination of the image photographing apparatus 100 is sensed, the controller 150 may control the image processor 140 to rotate a subject image in an opposite direction of an inclination direction of the image photographing apparatus in a live view

If an inclination of the image photographing apparatus is sensed, the controller 150 may control the image processor 140 to maintain a screen frame of the live view in a state of equilibrium and to rotate the subject image in an opposite direction of the inclination direction in the screen frame.

If an edge area of a screen frame of the live view deviates from a display screen, the controller 150 may control the image processor 140 to minimize a size of the rotated subject image.

When an inclination of the image photographing apparatus 100 is in a predetermined range, the controller 150 may control the image processor to rotate the subject image in an opposite direction of an inclination direction in the live view.

When an inclination of the image photographing apparatus 100 is sensed, the controller 150 may control the image processor 140 to rotate the subject image in an opposite direction as much as a rotation angle corresponding to an inclination of the image photographing apparatus 100 in the live view.

The controller 150 may control the display 120 to display a user interface for selecting whether to locate the subject image.

When the subject is photographed, the controller 150 may store the subject image in the first buffer, and when an inclination of the image photographing apparatus 100 is sensed, the controller 150 may read the subject image stored in the first buffer and store the subject image rotated in an opposite direction of an inclination of the image photographing apparatus 100 in the second buffer.

The controller 150 includes a hardware configuration such as a CPU, a cache memory, and a software configuration of an application that performs a specific purpose. When a control command regarding each element of the image photographing apparatus is read to a memory according to a system clock, an electronic signal is generated according to the read control command and each element of the hardware is operated.

The USB module 190 provides an interface with an external apparatus. If the USB module 190 is connected to a PC or other external apparatuses through a USB cable, a transmission and a reception of image data is processed. Also, a firmware transmission and reception for performing a firmware upgrade is processed.

The SDRAM 160 may be used for storing an image or for an image operation of CPU. In exemplary embodiment, a DDR SDRAM may be used, and the DDR SDRAM outputs data from the rise end and the descent end so that an output increases double in comparison of an output only from the rise end.

The flash memory 180 may store a firmware program, various control information according to a specification of the image photographing apparatus 100, set information of the image photographing apparatus 100 of a user input, a photographed image file and the like.

The memory card 170 may be configured to include a flash memory, and the memory card 170 is detachable from the image photographing apparatus 100. The memory card 170 may store a photographed image file.

The display 120 may be configured to display at least one of a user interface consisting of a letter, an icon and the like, an object, image photographing apparatus information, a dynamic image, and a still image. The display 120 may perform an electronic view finder function which displays a live view as described above.

However, the object is not limited to any particular type. That is, the object may be one of an application icon, a content icon, a thumbnail image, a folder icon, a widget, a list item, a menu and a content image. The application icon is an icon executing an application included in the image photographing apparatus 100 when a corresponding image is selected. The content icon is an icon playing a content when a corresponding image is selected. The thumb nail is an image which is reduced to a small size so that the image is displayed to be taken at a single glance. The folder icon is an icon which displays a file in a folder when a corresponding image is selected. The widget is an icon providing a user interface to execute an application icon immediately without selecting a menu of several steps. The list item is configured to display a file in a form of list, and the menu image is configured to display a selectable menu.

The display 120 may be designed with various display panels. In other words, the display 120 may be realized as various display techniques such as organic light emitting diodes (OLED), a liquid crystal display (LCD) panel, a plasma display panel (PDP), a vacuum fluorescent display (VFD), a field emission display (FED), an electro luminescence display (ELD) and the like. The display panel often consists of luminescent lights, but it does not exclude a reflective display (E-ink, P-ink, Photonic Crystal). Also, the display may be realized as a flexible display, a transparent display and the like.

The inputter 125 is configured to receive a user input. The inputter 125 may include at least one button 126 as illustrated in FIGS. 5A and 5B. Also, the inputter 125 may include a touch screen located on the display 120.

The at least one button 126 may be formed by a push type or a touch type on a front area, a side area, or a back area of the image photographing apparatus 100, and may include at least one of a power/lock button, a shutter button, a menu button, a home button, a back button, and a search button. When the button 126 is push type button, a corresponding control command may be generated and conveyed to the controller 150, and the controller 150 may control an operation of the image photographing apparatus 100 according to a corresponding control command. Also, the inputter 125 may receive a user input to select whether to rotate a subject image (horizontal compensating mode).

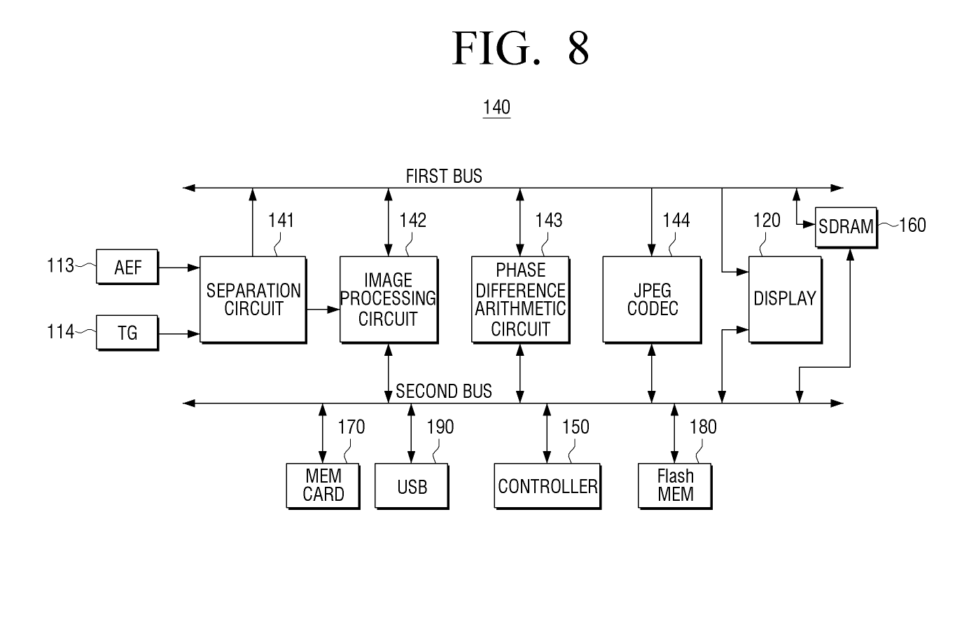

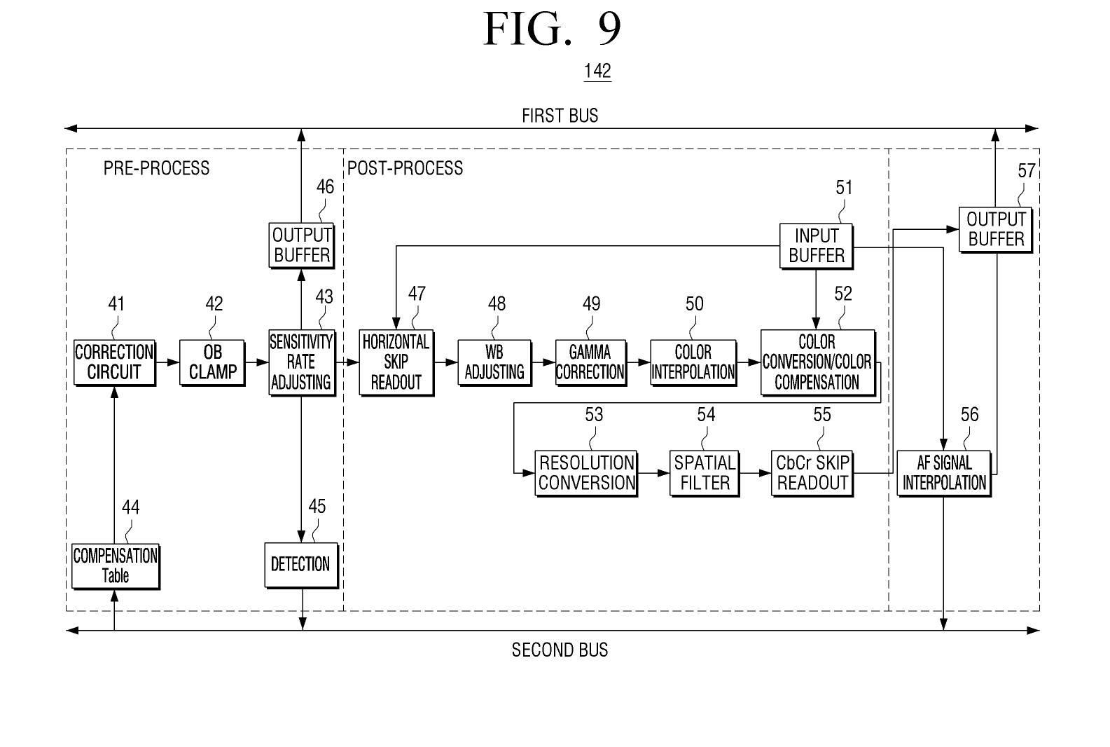

FIG. 8 is a block diagram illustrating a circuit configuration of the image processor 140 of the image photographing apparatus 100 according to an exemplary embodiment, and FIG. 9 is a block diagram illustrating a circuit configuration of an image processing circuit 142.

In FIG. 8, the image processor 140 of the image photographing apparatus 100 according to an exemplary embodiment may include a separation circuit 141, an image processing circuit 142, a phase difference arithmetic circuit 143, and a JPEG codec 144.

The separation circuit 141 separates a signal for generating an image (a signal readout from a general pixel) and a signal for calculating a phase difference (a signal readout from a phase difference pixel) from signals output from the solid image sensor device 112 and sampled by the AFE 113. This is to calculate a phase difference quickly using a signal for calculating the phase difference, to generate an image which is identical to a live view in parallel, and to perform an auto focusing quickly.

The image processing circuit 142 processes raw image data and makes the data into YCbCr data. As shown in FIG. 9, a defective pixel of raw image data may be corrected by a correction circuit 41. The correction circuit 41 corrects a defective pixel by referring to a compensation table 44, and an address of the defective pixel is registered in the compensation table 44. A correction is performed with respect to a pixel corresponding to an address from a surrounding pixel.

An option black (OB) clamping circuit 42 determines a black level of an image. The solid image sensor device 112 includes an OB area. The OB clamping circuit 42 detects a signal average value of an OB area, and determines a block level by a difference of each pixel value.

A sensitivity rate adjusting circuit performs adjusting a sensitivity rate which is different according to a color. The sensitivity rate adjusting circuit controls a sensitivity of R, G, B colors under standard illumination. Generally, a gain value of G is fixed to 1, and a sensitivity of R and B is adjusted accordingly.

When a still image is output, after adjusting a sensitivity rate, image data may be output through an output buffer 46. In this case, an image is generated in an interlace method, and thus, a post process is not able to be performed. However, if a live view image is output, an image is generated in a progressive method, and therefore, a post process may be performed immediately.

A horizontal skip readout circuit 47 performs a skip readout which reads out a part of a pixel line and skips the remaining pixel line, so that the number of pixels of raw image is reduced.

A white balance (WB) adjusting circuit 48 adjusts a white balance with respect to image data. A spectral distribution of illuminant light is different according to a photographing environment, and thus, even if a white subject is photographed, it may not be displayed white. A different gain value is given to R, G, B pixels, respectively, so that a signal level is adjusted. Generally, a gain value of G is fixed to 1, and a sensitivity of R and B is adjusted accordingly.

A gamma correction circuit 49 performs a gamma correction with respect to image data. A gradation conversion suitable to an output of the display 120 is performed through a gamma correction.

A color interpolation circuit 50 generates a general color image signal consisting of 3 colors per 1 pixel from a Bayer signal consisting of 1 color per 1 pixel.

A color conversion/color compensation circuit 52 converts a color space according to an output, and performs a color compensation. If necessary, a look up table (LUT) may be used. After the color conversion/color compensation, image data becomes YCbCr.

A resolution conversion circuit 53 converts a resolution and adjusts a size.

A spatial filter circuit 54 performs a spatial filter process with respect to image data. An edge emphasis of Y signal is performed, and a low pass filter process of Cb/CR signal is performed.

A CbCr skip readout circuit 55 performs a skip readout with respect to a Cb/Cr signal and converts to image data of YCbCr4:2:2. The image data is output through an output buffer 57, and recorded on the SCRAM 160 through the first bus.

In a case of a still image, a readout may be performed by an interlace method, but an adjoining pixel line does not exist, so a color interpolation might not be able to be performed directly. Accordingly, after a pre-process is over, an order of pixel lines in the SDRAM 160 is adjusted through the output buffer 46 and stored in a progressive shape. This image data is read again and input into an image processing circuit 132 through an input buffer 51.

However, if an exemplary embodiment is a still image mode, it is not limited to an interlace method, and it may be realized to readout with a progressive method.

However, in a case of a still image, it is may be necessary to generate a preview image or a thumb nail image which shows an image in a small size. It is made by omitting a part of pixel data as the skip readout.

In a case of a still image, if a continuous photographing function is performed in a brief time interval, a quick phase difference detection is needed, and thus, the technology described above may be applied.

An AF signal interpolation circuit 56 interpolates a phase difference pixel part with a general pixel value. The phase difference pixel is located between general pixels so that if this part is used as it is, a resolution deterioration may be generated. Accordingly, an interpolation may be performed using a surrounding general pixel.

A signal of a phase difference pixel which is separated from the separation circuit 141 is recorded on the SDRAM 160 through the first bus. A reading out with respect to a plurality of pixels is performed entirely, and then separation is performed, and thus, each difference pixel signal is accumulated in the SDRAM 160 for a short period.

A stored phase difference pixel signal is input to the phase difference arithmetic circuit 143 through the first bus. The phase difference arithmetic circuit 143 calculates a phase difference between phase difference pixels, and calculates a movement direction and a movement amount of a focus lens. The calculated movement amount is recorded on a register in the phase difference arithmetic circuit 143, and the controller 150 (that is, CPU) reads the calculated movement amount.

The controller 150 reads the calculated movement amount of a focus lens and generates a control command. The generated control command is transmitted to the motor driver so that the focus lens is driven.

The JPEG codec 144 compresses YCbCr data. Compressed image data is recorded on the SDRAM 160. The controller 150 reads the compressed image data recorded on the SDRAM 160 and records the compressed image data on the memory card 170, so that an image generating process is finished.

The image photographing apparatus 100, according to an exemplary embodiment, is not limited to an auto focusing technology using a phase difference pixel. In other words, the image photographing apparatus 100 according to various exemplary embodiments may include a technical configuration to perform a contrast auto focusing. It may be realized as a hybrid auto focusing technology using both of a phase difference auto focusing and a contrast auto focusing.

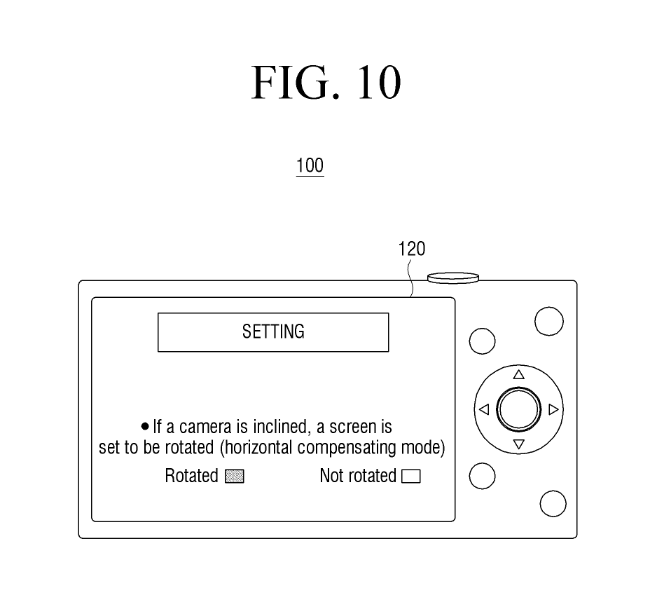

If the image photographing apparatus 100 is inclined, a user may directly set whether to incline a live view image in an opposite direction and FIG. 10 illustrates an exemplary embodiment of the case thereof.

FIG. 10 is a view illustrating a user interface according to an exemplary embodiment.

As illustrated in FIG. 10, if the image photographing apparatus is inclined, a user may determine whether to rotate a live view image in an opposite direction of an inclination direction of the image photographing apparatus 100 and the display 120 of the image photographing apparatus 100 displays a user interface for this. A mode of rotating a subject image in an opposite direction of an inclination direction of the image photographing apparatus 100 may be defined as a horizontal compensating mode. The user interface may be displayed to inquire whether to set the horizontal compensating mode to the user. The user may select an option which he/she wants by selecting or highlighting a check box displayed on the display. However, a user may wish to intentionally incline the image photographing apparatus 100 and photograph a subject, and thus, it is possible for the user to set a live view image not to be rotated (“Not rotated”) even if the image photographing apparatus 100 is inclined (a normal mode).

Hereinafter, an image photographing method according to various exemplary embodiments is explained.

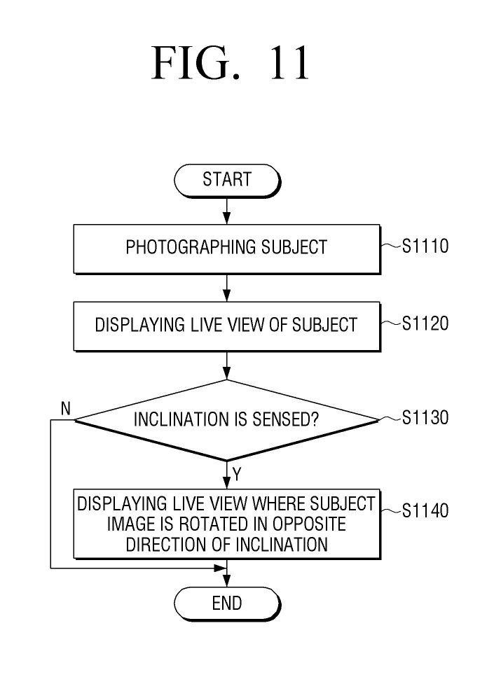

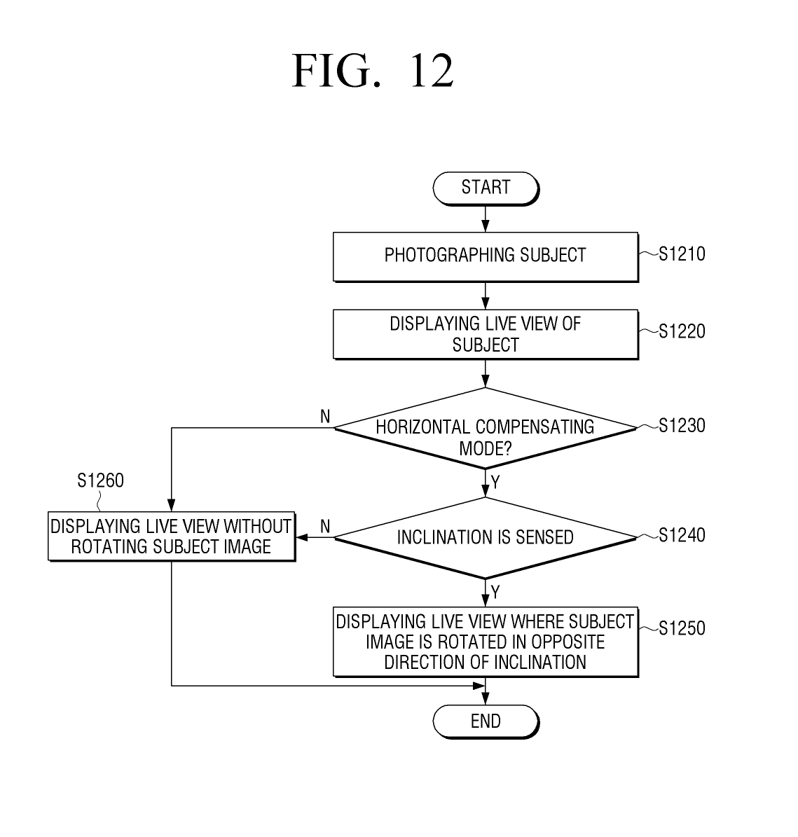

FIGS. 11 and 12 are flowcharts illustrating an image photographing method according to various exemplary embodiments.

Referring to FIG. 11, an image photographing apparatus according to an exemplary embodiment includes photographing a subject (S1110), displaying a live view with respect to the subject (S1120), and if an inclination of the image photographing apparatus is sensed (S1130-Y), rotating the subject image in an opposite direction of an inclination direction in the live view (S1140).

If an inclination of the image photographing apparatus is sensed, the rotating (S1140) may be maintaining a screen frame of the live view in a state of equilibrium and rotating the subject image in an opposite direction of the inclination direction in the screen frame.

If an edge area of a screen frame of the live view deviates from a display screen, the image photographing method may further include reducing a size of the rotated subject image.

If an inclination of the image photographing apparatus is sensed, the rotating (S1140) may rotate the subject image in the live view in an opposite direction as much as a rotation angle corresponding to an inclination of the image photographing apparatus.

If an inclination of the image photographing apparatus is in a predetermined range, the rotating (S1140) may rotate the subject image in an opposite direction of an inclination direction in the live view.

The image photographing method may further include displaying a user interface for selecting whether to rotate the subject image.

The image photographing method may further include in response to the subject being photographed, storing the subject image in the first buffer, and in response to an inclination of the image photographing apparatus being sensed, reading a subject image stored in the first buffer and storing a subject image rotated in an opposite direction of an inclination direction of the image photographing apparatus in the second buffer.

Referring to FIG. 12, an image photographing method according to another exemplary embodiment includes photographing a subject (S1210), and displaying a live view of a subject (S1220). If an image photographing apparatus is not set to a horizontal compensating mode (S1230-N), displaying a live view without rotating a subject image (S1260) is further included. However, if an image photographing apparatus is set to a horizontal compensating mode (S1230-Y), and an inclination is sensed (S1240-Y), a subject image displays a live view image where a live view is rotated in an opposite direction of an inclination direction (S1250).

The image photographing method described above may be stored as a program in a non-transitory computer readable medium. The non-transitory readable medium may be a medium which stores a data semi-permanently and is readable by an apparatus. Specifically, a CD, a DVD, a hard disk, a blu-ray disk, a USB, a memory card and ROM may be the non-transitory readable medium.

Also, the image photographing method described above may be equipped with a hardware IC chip in a shape of embedded software such as a FPGA, and be provided, and also may be included as a partial configuration in the image photographing apparatus 100 described above.

Desirable exemplary embodiments of the present inventive concepts were illustrated and explained above, but the present invention is not limited to the described exemplary embodiments. Also, the descriptions of the embodiments are intended to be illustrative, and not to limit the scope of the claims, and it would be appreciated by those skilled in the art that changes may be made to the embodiments without departing from the principles and spirit of the invention, the scope of which is defined in the appended claims.

What is claimed is:

1. An image photographing method, the method comprising:
photographing a subject;
displaying a live view with respect to the subject; and
in response to sensing an inclination of an image photographing apparatus, rotating the subject image in the live view in an opposite direction of the inclination of the image photographing apparatus.

2. The method as claimed in claim 1, further comprising:
in response to sensing the inclination of the image photographing apparatus, maintaining a screen frame of the live view in a state of equilibrium and rotating the subject image within the screen frame in an opposite direction of the inclination of the image photographing apparatus.

3. The method as claimed in claim 2, further comprising:
in response to an edge area of the screen frame of the live view deviating from a display screen, reducing a size of the rotated subject image.

4. The method as claimed in claim 1, further comprising:
in response to sensing the inclination of the image photographing apparatus, rotating the subject image in an opposite direction by an amount equal to a rotation angle corresponding to an inclination of the image photographing apparatus in the live view.

5. The method as claimed in claim 1, wherein
in response to the inclination of the image photographing apparatus being in a predetermined range, rotating the subject image in the live view in an opposite direction of the inclination of the image photographing apparatus; and
in response to the inclination of the image photographing apparatus being outside of the predetermined range, not rotating the subject image in the live view.

6. The method as claimed in claim 1, further comprising:
displaying a user interface for selecting whether to rotate the subject image.

7. The method as claimed in claim 1, further comprising:
in response to the subject being photographed, storing the subject image in a first buffer; and
in response to sensing the inclination of the image photographing apparatus, reading the subject image stored in the first buffer and storing the subject image rotated in an opposite direction of the inclination of the image photographing apparatus in a second buffer.

8. An image photographing apparatus, comprising:
an image capturer configured to capture an image of a subject;
a display configured to display a live view with respect to the subject;
an inclination detector configured to detect an inclination of the image photographing apparatus;
an image processor configured to process the live view; and
a controller configured to, in response to sensing an inclination of the image photographing apparatus, control the image processor to rotate the subject image in the live view in an opposite direction of the inclination of the image photographing apparatus.

9. The image photographing apparatus as claimed in claim 8, wherein the controller, in response to sensing an inclination of the image photographing apparatus, controls the image processor to maintain a screen frame of the live view in a state of equilibrium and to rotate the subject image within the screen frame in an opposite direction of the inclination of the image photographing apparatus.

10. The image photographing apparatus as claimed in claim 9, wherein the controller, in response to an edge area of the screen frame of the live view deviating from a display screen, controls the image processor to reduce a size of the rotated subject image.

11. The image photographing apparatus as claimed in claim 8, wherein the controller:
in response to the inclination of the image photographing apparatus being in a predetermined range, controls the image processor to rotate the subject image in the live view in an opposite direction of the inclination of the image photographing apparatus; and
in response to the inclination of the image photographing apparatus being outside of a predetermined range, controls the image processor to not rotate the subject image in the live view.

12. The image photographing apparatus as claimed in claim 8, wherein the controller, in response to sensing the inclination of the image photographing apparatus, controls the image processor to rotate the subject image in the live view in an opposite direction and by an amount equal to a rotation angle corresponding to the inclination of the image photographing apparatus.

13. The image photographing apparatus as claimed in claim 8, wherein the controller controls the display to display a user interface to select whether to rotate the subject image.

14. The image photographing apparatus as claimed in claim 13, further comprising:
an inputter configured to receive a user input to select whether to rotate the subject image.

15. The image photographing apparatus as claimed in claim 8, further comprising:
a first buffer; and
a second buffer,
wherein the controller, in response to the subject being photographed, stores the subject image in the first buffer, and in response to sensing the inclination of the image photographing apparatus, reads the subject image stored in the first buffer and stores the subject image rotated in an opposite direction of the inclination of the image photographing apparatus in the second buffer.

16. A non-transitory recordable medium which has recorded thereon a program for implementing the image photographing method according to claim 1.

17. An image photographing apparatus comprising:
an image capturer configured to capture an image of a subject;
a display configured to display a live view of the image of the subject; and
a controller configured to, in response to detecting an inclination of the image photographing apparatus, rotate the image of the subject in the live view in a direction opposite to the inclination of the image photographing apparatus.

18. The image photographing apparatus of claim 17, wherein the display further comprises a user interface configured to receive an input from a user for selecting whether to rotate the image of the subject, and
in response to the user selecting to not rotate the image of the subject, the controller is configured to not rotate the image of the subject in the live view.

19. The image photographing apparatus of claim 17, wherein in response to detecting the inclination of the image photographing apparatus, the display is further configured to display a screen frame, and the controller is configured to rotate the image of the subject within the screen frame in a direction opposite to the inclination of the image photographing apparatus.

20. The image photographing apparatus of claim 17, wherein the detecting the inclination of the image photographing apparatus is performed with an accelerometer.
